(19) United States
(12) Patent Application Publication
(10) Pub. No.: US 2001/0006568 A1
(43) Pub. Date: Jul. 5, 2001

(54) 11/2 X 2 Optical switch

(76) Inventors: Nigel Copner, Fremont, CA (US); Adam D. Cohen, Fremont, CA (US); Matthew Derstine, Sunnyvale, CA (US)

Correspondence Address: Lacasse & Associates, Suite 806, 2001 Jefferson Davis Highway, Arlington, VA, 22202, US

(21) Appl. No.: 09/739,369

(22) Filed: Dec. 19, 2000

Related U.S. Application Data
(63) Continuation-in-part of application No. 09/594,820, filed on Jun. 16, 2000.
Application No. 09/594,820 is a continuation-in-part of application No. 09/637,599, filed on Aug. 15, 2000.
Application No. 09/637,599 is a division of application No. 09/334,502, filed on Jun. 17, 1999, now Pat. No. 6,154,585.

(51) Int. Cl. G02B 6/35

(52) U.S. Cl. 385/16; 385/34

(57) ABSTRACT

An optical switch is disclosed having 4-ports. The switch consists of a first GRIN lens having 2 ports adjacent its outwardly facing end face. A second GRIN lens is disposed to receive light from the first GRIN lens and has two ports adjacent its outer end face. In a first state, a first port from the first GRIN lens couples light with a first output port of the second GRIN lens. In a second state, a movable optical element in the form of a light transmissive element, having at least one refractive index gradient, is disposed in the path between first and second GRIN lenses, providing a connection between a port of the first GRIN lens and a second port of the second GRIN lens. Hence a 1½×2 optical switch is disclosed.

This application is a continuation-in-part of Ser. No. 09/594,820 filed Jun. 19, 2000 and Ser. No. 09/637,599 filed Aug. 15, 2000 which is a divisional of Ser. No. 09/334,502 filed Jun. 17, 1999 now issued as U.S. Pat. No. 6,154,585 on Nov. 28, 2000.

### FIELD OF THE INVENTION

The present invention relates to an optical switch and in particular, to an optical switch having a light transmissive element, with at least one refractive index gradient, to steer a beam of light.

### BACKGROUND OF THE INVENTION

Optical switches of various kinds are well known for selectively switching light from a waveguide, such as optical fiber or light-conducting path, to another.

To fulfill this requirement, it has been well known to provide 2×2 optical switches having two ports on each side, wherein the switch is configurable to make a connection between ports 1 and 2 and simultaneously to provide a connection between ports 3 and 4. Alternatively, such switches are configurable to provide simultaneous connections between ports 1 and 4, and ports 3 and 2. Hence these prior art switches have two states; a first state wherein two bar connections are formed and a second state wherein 2 cross connections are formed. Providing suitable coupling in both switching states, and providing a switch that is fast enough and tolerant of physical disturbances, is a daunting task most switch manufacturers face.

A well known optical switch made by JDS Fitel Inc. has been sold in the United States since Feb. 11, 1992 under the product number SR22xx-ONC. This optical switch includes a pair of GRaded INdex (GRIN) lenses having a reflector or mirror that can be selectively disposed therebetween. Each GRIN lens has two ports offset from the optical axis (OA) of the lens.

In a graded index medium that has a refractive index that varies with position, optical rays follow curved trajectories, instead of straight lines. By judicious selection of the refractive index, a GRIN rod can behave like a conventional optical element such as a prism or a lens. Lenses of this type are produced under the trade name “SELFOC”; the mark is registered in Japan and owned by the Nippon Sheet and Glass Co. Ltd. GRIN lenses are used extensively as a means of coupling optical signals from one waveguide such as an optical fiber, to another, for example, in optical switches. The use of GRIN lens provides a number of advantages over other conventional lenses. For example, GRIN lenses are relatively inexpensive, compact, and furthermore have parallel flat end faces. In particular, the flat end face of the GRIN lens allows a single lens to be used as a means of collimating or focusing light.

An optical arrangement is shown in FIG. 1, wherein two quarter pitch GRIN lenses 10a and 10b are disposed so that their collimating ends are adjacent one another in a back to back relationship. A very thin optical element in the form of a filter 12 is sandwiched therebetween. The filter 12 can be coated directly on one of the inwardly facing end faces of the lenses, or alternatively may be coated on a substrate that is antireflection coated and sandwiched between the two GRIN lenses 10a and 10b. The GRIN lens 10a has an input fiber 11a on its focus end face while GRIN lens 10b has an output fiber on its focus end face. Fibers 11a and 11b have optical axes that are parallel to the optical axis of GRIN lenses 10a and 10b. Since the beam traversing the lenses 10a and 10b about the filter element 12 is at a location substantially coincident with the optical axes of the GRIN lenses, the light input orthogonal to the end face of the lens 10a at port P₁, propagates through the filter 12 and through the second lens 10b and exits at port P₂ as a focused beam that is parallel to the input beam and the optical axes of the lenses 10a and 10b.

FIG. 2 illustrates an offset that occurs when a gap is present between a pair of coaxial GRIN lenses 12a and 12b. The beam exiting the lens 12a intersects the end face equidistant from the optical axis indicated by lines 20a and 20b, which define the outer most limits of the beam as it traverses the lens 12a end face. However, due to the gap between the lenses 12a and 12b, the beam traverses the inwardly facing end face of the lens 12b having its outermost limits defined by the locations 22a and 22b which are not equidistant from the optical axis OA of the second lens 12b. This beam shift downward results in the output beam being directed upward at an angle to the local optical axis but along the optical axis of an output optical fiber 14b. Accordingly, substantial coupling losses may occur between an input port on a first GRIN lens and an output port on a second GRIN lens, when the input and output ports are disposed adjacent and parallel to the optical axes of the two GRIN lenses, and wherein a gap separating the GRIN lenses causes a beam propagating from the input port through the first GRIN lens to be shifted as it traverses the element towards the output port and enters the second lens at an offset to the optical axis of the lens. To overcome this disadvantage and to provide a more efficient optical coupling, the output fiber 14b is provided at an angle θ>0 degrees with respect to the optical axis of the lens.

It is also possible, as shown in FIG. 3, to launch the beam 30 at a judiciously selected angle θ_{S} at the left input end face of the GRIN lens 16b in such a way that the beam is selectively directed towards a desired output port location at the right output end face of the GRIN lens 16b. Moreover, by ensuring that the beam has its centre substantially coincident with the optical axis OA of the lens, the beam thus propagates through the lens 16b and exits the output end of the lens parallel to the OA of the lens.

From a manufacturing standpoint, when using GRIN lenses in optical switches or routers, it is preferable to use a transmissive switching optical element, in which zero or an even number of rigidly physically coupled internal reflections in each plane, and/or any number of refractions, are imposed on the incident light between the lenses rather than a reflective element imposing one reflection, to route, shift, or direct a beam from one port to an alternate port when the element is disposed between lenses. Thus, by providing a transmissive element such as a prism, the switch is much less sensitive to angular deviation and misalignment of the element than a switch using a reflective element such as a mirror. For example, in comparing angular sensitivity based on a 0.05 dB excess insertion loss criterion, an existing single mirror-based switch has a typical angular tolerance of 0.007°. An existing prism-based switch has an angular tolerance of 0.03°, wherein a switch based on a glass plate, with a linear refractive index gradient in the vertical direction, has an angular tolerance of ±0.2° for a penalty of ±0.05 dB.

### SUMMARY OF THE INVENTION

In accordance with this invention, there is provided an optical switch comprising:

at least one input port on one side for launching a beam of light along an optical path;

at least two output ports on an opposite side for receiving the beam of light, one of the at least two output ports optically coupled to the at least one input port;

a light transmissive element, having at least one refractive index gradient, said element movable into and out of the optical path;

said element movable between first, and second positions corresponding to first, and second connect states, respectively;

wherein in the first connect state a single connection between the at least one input port and a first output port is provided; and

wherein in the second connect state a single connection between the at least one input port and a second output port is provided.

In accordance with this invention, there is further provided a method for switching a beam of light from one of a plurality of output ports to another, comprising the steps of:

receiving a beam of light at an input port;

transmitting the beam of light along an optical path to at least one of a plurality of output ports; and

inserting a light transmissive element, having at least one refractive index gradient, into the optical path;

whereby the beam of light switches from a first connect state, the first connect state being a single connection between the input port and a first output port, of the plurality of output ports, to a second connect state, the second connect state being a single connection between the input port and another predetermined output port of the plurality of output ports.

In accordance with another aspect of this invention, there is provided an optical switch comprising:

at least one input port on one side for launching a beam of light along an optical path;

at least two output ports on an opposite side for receiving the beam of light, one of the at least two output ports optically coupled to the at least one input port;

a light transmissive element, having a refractive index gradient, disposed in the optical path;

means for controlling the refractive index gradient of said element.

In accordance with this invention, there is further provided a method for switching a beam of light from one of a plurality of output ports to another, comprising the steps of:

receiving a beam of light at an input port;

transmitting the beam of light along an optical path, with a light transmissive element, having a refractive index gradient, disposed therein, to at least one of a plurality of output ports; and

controlling the refractive index gradient to affect switching a beam of light between a first connect state, the first connect state being a single connection between the input port and a first output port, of the plurality of output ports, and a second connect state, the second connect state being a single connection between the input port and another predetermined output port of the plurality of output ports.

In accordance with anther aspect of this invention, there is further provided a method for switching a beam of light from one of a plurality of output ports to another, comprising the steps of:

receiving a beam of light at an input port;

transmitting the beam of light along an optical path to at least one of a plurality of output ports; and

moving a light transmissive element, having at least one refractive index gradient, disposed in the optical path;

whereby the beam of light switches from a first connect state, the first connect state being a single connection between the input port and a first output port, of the plurality of output ports, to a second connect state, the second connect state being a single connection between the input port and another predetermined output port of the plurality of output ports.

### BRIEF DESCRIPTION OF THE DRAWINGS

Exemplary embodiments of the invention will now be described in conjunction with the drawings in which:

FIG. 1 is a side view of a conventional block diagram of prior art depicting an optical device having a pair of coaxial GRIN lenses and a very thin filtering element disposed therebetween;

FIG. 2 is a side view of a prior art diagram of a coupling system wherein losses are reduced by angling a receiving output fiber with respect to the angle of the input fiber;

FIG. 3 is a side view of a diagram of a GRIN lens receiving a collimated beam concentric with the optical axis and angled such that it exits the lens at a selected output port parallel to the optical axis of the lens;

FIG. 4a is a side view diagram showing a connect state in accordance with an embodiment of the invention wherein two beams of light are collimated and focussed by a pair of GRIN lens;

FIG. 4b is a side view diagram showing a connect state in accordance with an embodiment of the invention wherein one of the two input beams of light is collimated and focussed to an output port by a pair of GRIN lenses having a light transmissive element, having at least one substantially linear or near-linear refractive index gradient in the vertical direction, disposed therebetween;

FIG. 5a is a side view diagram showing a connect state in accordance with an embodiment of the invention wherein two input beams of light are collimated and focused to two output ports by a pair of GRIN lens having a light transmissive bipartite element with two opposing substantially linear or near-linear refractive index gradients in the vertical direction disposed in a first position with one of the substantially linear or near-linear refractive index gradients therebetween.

FIG. 5b is a side view diagram showing a connect state in accordance with an embodiment of the invention wherein one input beam of light is collimated and focused to an output port by a pair of GRIN lens having a light transmissive bipartite element with two opposing substantially linear or near-linear refractive index gradients in the vertical direction in a second position that has the other substantially linear or near-linear refractive index gradient therebetween.

FIG. 6a is a side view diagram showing a first connect state in accordance with an embodiment of the invention wherein two input beams of light are collimated and focused to two output ports by a pair of GRIN lens having a light transmissive element having a refractive index gradient, said refractive index gradient controlled thermally or electro-optically, disposed therebetween.

FIG. 6b is a side view diagram showing a second connect state in accordance with an embodiment of the invention wherein one input beam of light is collimated and focused to an output port by a pair of GRIN lens having a light transmissive element having a refractive index gradient, said refractive index gradient controlled thermally or electro-optically, disposed therebetween.

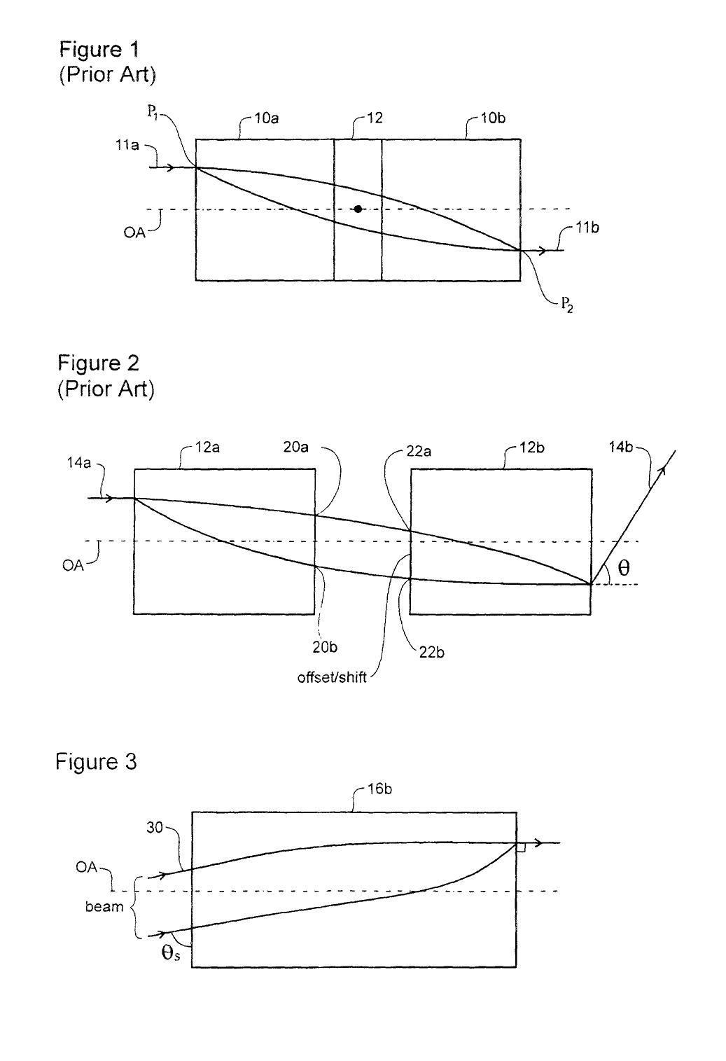

### DETAILED DESCRIPTION

Preferred embodiments of this invention are based on the use of a light transmissive glass element with at least one refractive index gradient to direct light from at least one input port to at least one output port.

Lightpath GRADIUM™ is a material that is fabricated with a refractive index gradient in one dimension. The GRADIUM™ material is manufactured using plates of glass having different refractive indices laid one on top of another and annealing them. The result is a glass plate with a homogeneous refractive index in the orthogonal plane giving an axial gradient which when rotated 90° from its conventional orientation can be used for a substantially linear or near-linear refractive gradient index in the vertical direction. The term substantially linear or near-linear is relative to the scale of measurement for determining the gradient. Large delta measurements could yield a linear refractive index gradient, while smaller delta measurements could yield an observed saw tooth change in the refractive index rather than an observed linear or smooth change. It is well known in the art that a measurement of the linearity can be determined by calculating the standard deviation of the refractive index gradient compared to a linear refractive index gradient. It is expected that a near-linear refractive index gradient would have a standard deviation less than 20% and preferably less than 5% from a linear refractive index gradient. The higher the measured standard deviation is from linearity the higher the losses in the optical system. So the term linear is relative to the scale of the measurement and is better qualified to substantially linear or near-linear refractive index gradient. A glass element with a substantially linear or near-linear refractive index gradient in the vertical direction is hereafter referred to as a modified glass element. This modified glass element preferably has parallel sides but is not restricted only to parallel sides. The modified glass element was chosen to have a refractive index gradient to simulate a wedge shaped refractive element. Thus exactly parallel sides are not a requirement to enable the invention. This is a passive solution to the problem but the substantially linear or near-linear refractive index gradient in the vertical direction could be provided by active solutions such as by thermo-optic or electro-optic or other means that provide a changeable index gradient without moving parts.

In modeling the systems discussed herein the light is expected to have a plane wavefront not a Gaussian distribution. In practice the light beam has a Gaussian distribution and at the focal point, minimum Gaussian beam waist, of the Gaussian beam it is expected to have a near planar wavefront. That is a wave in which wavefronts are parallel to a plane normal to the direction of propagation. The use of a planar wavefront to model the refractive index of a material introduces errors since the light actually has wavefronts that are near planar but are not planar. For this same reason the GRIN lenses achieve near-collimated light not collimated light.

It is possible to design the imaging system to employ shorter, less than ¼pitch, GRIN lenses coupled via transmissive spacers to the input/output ports. Using Gaussian optics design principles the minimum Gaussian beam waist can be thereby set at the midpoint of the optical path. That is the best design is an average of the optical path with the optical element in between the GRIN lenses and the optical path with the optical element removed from between the GRIN lenses. This is done in order to optimise output coupling efficiency. In this case the optimum design yields beam positions offset by equal and opposite distances relative to the input/output GRIN lens centers whilst still maintaining the condition of beam-OA parallelism in the focal plane at the output ports. In addition to allowing optimum coupling performance at finite lens separation, this approach permits reduction of the beam angle relative to the OA between the GRIN lenses. The substantially linear or near-linear refractive index gradient, on which the angular beam steering or directing is based, is in practice limited in magnitude. The effect is proportional to the interaction length in the material. It is desirable to limit or reduce the thickness of the near-linear refractive gradient index glass element for reasons of economy and also to facilitate the above-mentioned optimised optical design for finite GRIN lens separation and associated reduced inter-lens beam angle. Furthermore a reduced interaction length reduces the slight deleterious effects of the finite index gradient nonlinearity in terms of beam aberration and associated output port coupling loss. Thus design iterations reducing the pitch of the GRIN lenses, the inter-lens beam angle and the thickness of the substantially linear or near-linear refractive gradient index glass element represent a virtuous cycle. This virtuous cycle is of course subject to the constraints of a practical minimum thickness of the latter part and an empirically observed minimum GRIN lens pitch that remains consistent with efficient coupling, typically in the range of 0.1 to 0.12.

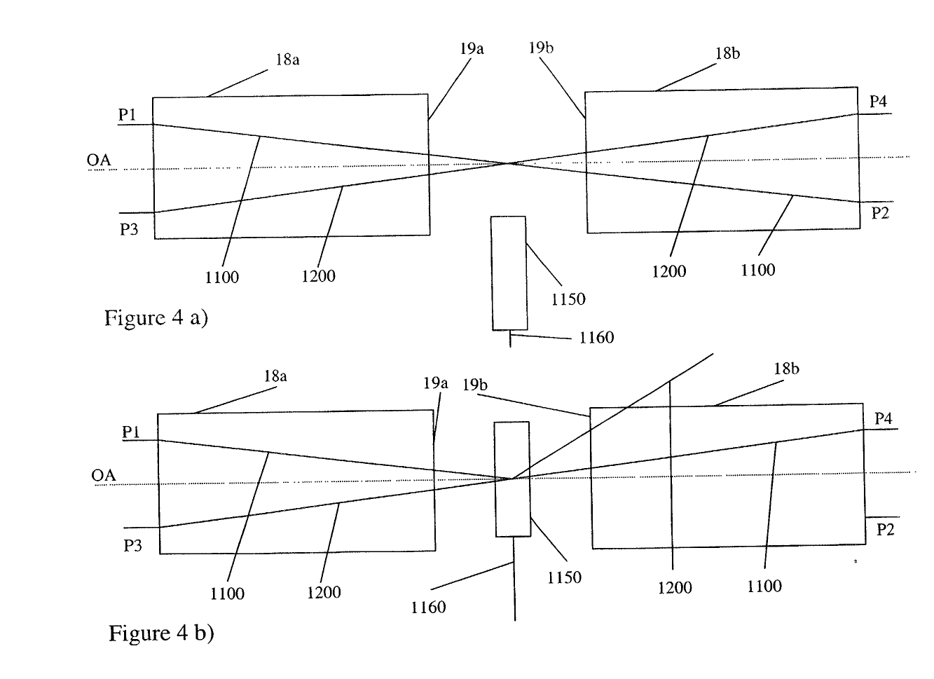

With reference to FIG. 4a, there is a first connect state where the modified glass element 1150 is moved out of the optical path by the actuator 1160. There are two GRIN lenses 18a and 18b along the same optical axis OA with input ports P1, and P3 and output ports P2, and P4. A beam of light 1100, parallel to the OA, is launched into input port P1 and is collimated by GRIN lens 18a and exits said lens via surface 19a. Light beam 1100 then enters GRIN lens 18b via surface 19b and is focused by GRIN lens 18b to exit at output port P2 substantially parallel to the optical axis of the second GRIN lens 18b. A beam of light 1200, parallel to the OA, launched into input port P3 is collimated by GRIN lens 18a to exit at surface 19a. Light beam 1200 then enters GRIN lens 18b at surface 19b and is focused by GRIN lens 18b to exit GRIN lens 18b at output port P4 substantially parallel to the optical axis of second GRIN lens 18b. Thus light beams entering input ports P1 and P3, respectively, travel through the optical system and exit at output ports P2 and P4, respectively.

With reference to FIG. 4b, a second connect state is illustrated where the modified glass element 1150 is moved into the optical path, by the actuator 1160, essentially orthogonal or essentially perpendicular to the refractive index gradient.

A beam of light 1100 launched into input port P1 of GRIN lens 18a travels to the same location on surface 19a as previously, however, light beam 1100 will then be refracted by the modified glass element 1150 to enter surface 19b at a different place than in the previous case. GRIN lens 18b then focuses light beam 1100 to exit at output port P4 substantially parallel to the optical axis of second GRIN lens 18b. Light beam 1200 is refracted vertically and is focused by the GRIN lens 18b to a point where there is no port, in the illustrated embodiment.

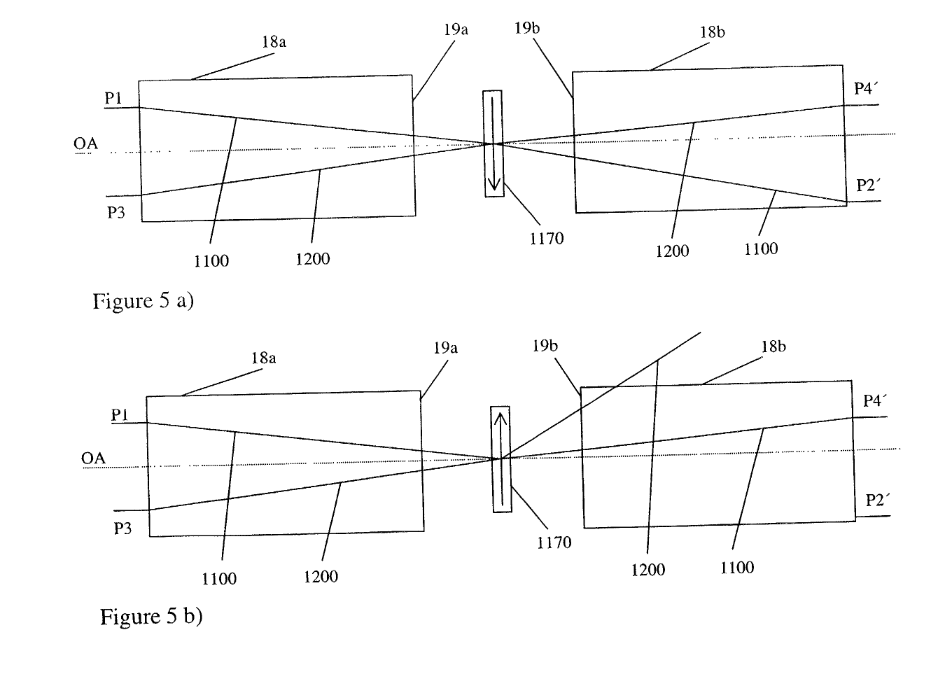

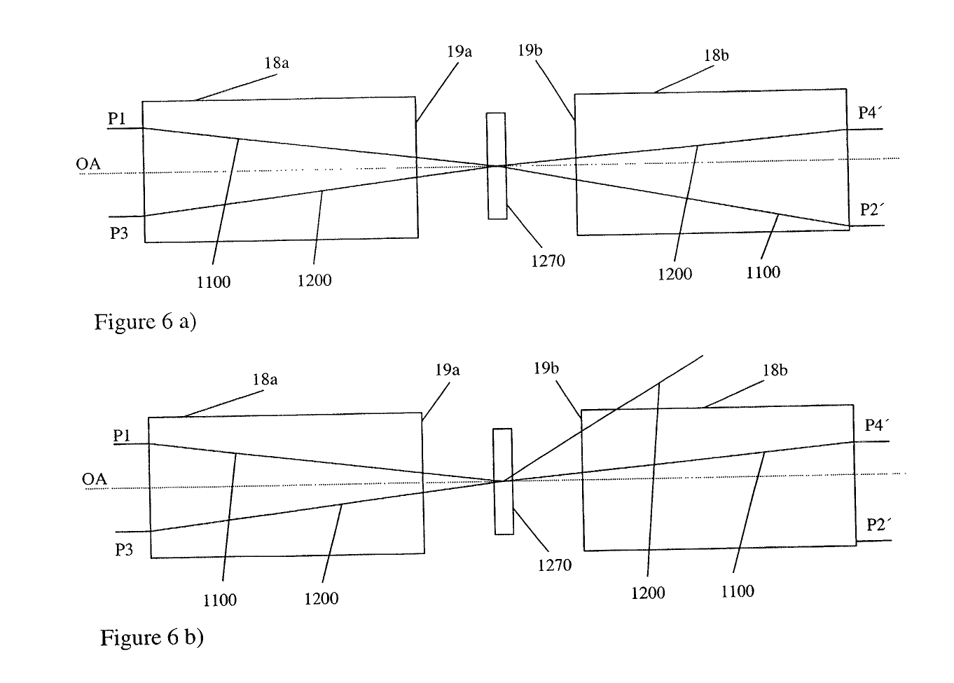

In a practical situation use of substantially linear or near-linear refractive index gradient, such as when deploying GRADIUM™ material, there is typically a preferred section of the refractive index gradient through which the beam should pass. Consequently there is some finite sensitivity—in terms of output port coupling efficiency—to linear displacement of the optic in the vertical direction. That is the same sense as the refractive index gradient direction as indicated in the figures. In such cases the motion of the substantially linear or near-linear refractive gradient index optic in switching between states should be in a direction essentially orthogonal or essentially perpendicular to the plane of the paper of the schematic FIGS. 4a to 5b.

With reference to FIG. 5a, which illustrates two GRIN lens 18a and 18b, two input ports P1, and P3, two output ports P2′, and P4′, and a modified glass bipartite element 1170 between GRIN lenses 18a and 18b in a first position, representing a first connect state. The modified glass bipartite element 1170 is constructed from two modified glass elements 1150 that have been further ground to be thinner than the modified glass element 1150. These additionally modified glass elements are then arranged with opposite but other-wise equal substantially linear or near-linear refractive index gradients in a vertical direction and are bonded one on top of the other in order to complete the construction of the modified glass bipartite element 1170. The thickness is less to decrease the optical aberrations and losses introduced into the optical beam by the modified glass bipartite element 1170. The arrow on the modified glass bipartite element 1170 indicates an increasing substantially linear or near-linear index of refraction in the modified glass bipartite element 1170. An actuator, that is not shown since it is directly behind the modified glass bipartite element 1170, moves the modified glass bipartite element between a first position and a second position. The first position, representing a first connect state, allows input beams 1100 and 1200 to be collimated and focused by GRIN lenses 18a and 18b and exit on output ports P2′, and P4′, respectively. Note that optical outputs P2′, and P4′ are located in different positions on the second GRIN lens 18b than the output ports P2, and P4 of FIG. 4. This is due to the modified glass bipartite element disposed in the optical path. The beams of light are deflected toward the higher index of refraction therefore as the arrow is pointing downward in FIG. 5a the beams of light have been refracted to lower positions on the output side of the second GRIN lens 18b.

With reference to FIG. 5b, the modified glass bipartite element 1170 is shown in the second position, representing the second connect state. A light beam 1100 enters input port P1, substantially parallel to the OA, is collimated by GRIN lens 18a and impinges on modified glass bipartite element 1170. The modified glass bipartite element 1170 in the second connect state has a substantially linear or near-linear refractive index gradient in the vertical direction that is opposite to the substantially linear or near-linear refractive index gradient in the vertical direction of the first connect state. Therefore beam 1100 is refracted upwards in FIG. 5b and is focussed by GRIN lens 18b and exits on output port P4′. A light beam 1200 enters input port P3, substantially parallel to the OA is collimated by GRIN lens 18a and impinges on modified glass bipartite element 1170. Light beam 1200 is then refracted upwards in FIG. 5b and is focused by GRIN lens 18b to a point on the end face of GRIN lens 18b where there is no port, in the illustrated embodiment. Thus in the first connect state light beams 1100 and 1200 on input ports P1 and P3, respectively, exit the optical system on output ports P2′ and P4′, respectively. While in the second connect state light beam 1100 on input port P1 exits on output port P4′ and light beam 1200 on input port P3 is focused by the GRIN lens 18b to a point where there is no port, in the illustrated embodiment.

This embodiment is functional, however, it will not yield both output beams parallel to the OA, nor will the beam angles be equal or the beam separations be precisely equal to the input port separation. Hence, there will be finite and uneven coupling loss penalties if a standard double-bore fiber capillary is used to form the output ports. A further improvement to this embodiment is to have a finite tilt angle between the input and output lens, or lens/spacer assemblies. This maintains symmetric straddling of the output port positions relative to the local OA, at the same separation as the input ports, and with the output beams being substantially parallel relative to the local OA.

One advantage of using a modified glass bipartite element is that the modified glass bipartite element is not as thick as the modified glass element and therefore causes less loss and distortion to the optical signal that is being switched. A second advantage is that because one substantially linear or near-linear refractive index gradient in the vertical direction is always in the optical path the modified glass bipartite element may need less movement in order to affect a change in the imaging location of the optical signal, i.e. output port.

Another embodiment involves the construction of a multipartite glass element. Each section of the multipartite glass element is formed from glass have a different index gradient or direction of index gradient than glass element sections on either side of it. An optical beam launched into an input port has its optical path modified by changing the position of the multipartite element. Thus, the multipartite glass element is used to switch the input beam from one of a plurality of output ports to another predetermined output port of a plurality of output ports. This switching can be done in a sequential manner or discontinuously, that is, in any increment physically possible to obtain using the actuator.

Using active solutions, as previously mentioned, to obtain a refractive index gradient provides an additional embodiment. Such embodiments would include but not be restricted to the use of a refractive index gradient optical element that is bonded to a substrate. This substrate is then heated or cooled in a manner that results in changing the refractive index gradient of the optical element. This shifting of the gradient then changes the refractive index gradient of the portion of the optical element that the optical beam is passing through, refracting the optical beam to a different output location. The optical path is thus changed from a first output port, of a plurality of output ports, to another predetermined output port of the plurality of output ports. This results in the ability to switch the optical beam through a plurality of output ports one a time but not necessarily sequentially. That is the optical beam would not have to be switch through each output port to get to a preferred output port but could be diverted directly to the preferred output port by heating or cooling the element to obtain the refractive index gradient, in the portion of the optical element that contains the optical beam, that shifts the optical beam to said preferred output port.

An embodiment in which the refractive index gradient is produced by electro-optic means. This is achieved by designing electrodes disposed parallel to one another on two sides of the optical transmissive element, such that the electric field produced in the optical element is uniform and homogeneous in the direction normal to the electrodes; the electrodes may be transparent (e.g. of indium tin oxide material) if they are to be applied on the optically transmissive faces. One electrode would be designated as a ground plane (0 volts). The other electrode would preferably be designed to have significant resistance, such that with a finite voltage applied to one end and zero volts applied to the other end, a gradient of electrical potential would be created. The interaction with the parallel ground electrode would then provide a gradient of electric field in the direction desired. Through the Pockels, or linear electro-optic, effect the refractive index of the optical element is modified at a given local position by the amount delta (n), according to:

delta(n)=−0.5*n´{3}_{eff}r_{eff}E_{local}

where n_{eff} and r_{eff} are effective refractive index (a generalization to encompass birefringent materials) and effective Pockels' coefficient experienced by the propagating light, and E_{local} is the local electric field.

An embodiment in which the refractive index gradient is produced by elasto-optic means. This would be achieved by designing a mounting structure capable of applying a stress to the optical transmissive element which can be varied in magnitude as a function of distance in a desired direction, hence imparting a stress, and consequently, strain gradient in the optical element. The amounts of strain induced by given applied stresses are related through elements of the compliance tensor. Changes in refractive index are in turn related to induced strains through elements of the elasto-optic tensor. Most normally homogeneous optically transmissive materials will become birefringent on applying stress; hence use of this technique might necessitate a polarization-diverse architecture to avoid unwanted polarization-dependent coupling loss.

Further embodiments may be envisioned without departing from the spirit and scope of the invention presented herein.

What is claimed is:

1. An optical switch comprising:
at least one input port on one side for launching a beam of light along an optical path;
at least two output ports on an opposite side for receiving the beam of light, one of the at least two output ports optically coupled to the at least one input port;
a light transmissive element, having at least one refractive index gradient, said element movable into and out of the optical path;
said element movable between first, and second positions corresponding to first, and second connect states, respectively;
wherein in the first connect state a single connection between the at least one input port and a first output port is provided; and
wherein in the second connect state a single connection between the at least one input port and a second output port is provided.

2. An optical switch as defined in claim 1, comprising an actuator for moving the light transmissive element into and out of the optical path.

3. An optical switch as defined in claim 2, wherein the light transmissive element has a single refractive index gradient in one direction, said element movable into and out of the optical path in a direction essentially perpendicular to the refractive index gradient.

4. An optical switch as defined in claim 3 comprising at least a first GRIN lens optically coupled to the at least one input port for collimating the beam of light onto the light transmissive element in the second connect state.

5. An optical switch as defined in claim 4, comprising at least a second GRIN lens optically coupled to at least two output ports for focussing the collimated beam of light from the first GRIN lens to the first output port in the first connect state and from the light transmissive element to the second output port in the second connect state.

6. An optical switch as defined in claim 1, comprising a first GRIN lens and a second GRIN lens, the first GRIN lens optically coupled to the at least one input port and the second GRIN lens optically coupled to the at least two output ports, the lenses being arranged such that their inner end faces are facing one another to allow the beam of light launched into the at least one input port to couple to one of the at least two output ports on the outer end face of the second lens.

7. An optical switch as defined in claim 1, wherein the light transmissive element is a light transmissive bipartite element with two opposing refractive index gradients.

8. An optical switch as defined in claim 7, comprising a first GRIN lens and a second GRIN lens, the first GRIN lens optically coupled to the at least one input port and the second GRIN lens optically coupled to the at least two output ports, the lenses being arranged such that their inner end faces are facing one another whereby the light transmissive bipartite element is positioned to allow the beam of light launched into the at least one input port to couple to one of the at least two output ports on the outer end face of the second GRIN lens.

9. A method for switching a beam of light from one of a plurality of output ports to another, comprising the steps of:
receiving a beam of light at an input port;
transmitting the beam of light along an optical path to at least one of a plurality of output ports; and
inserting a light transmissive element, having at least one refractive index gradient, into the optical path;
whereby the beam of light switches from a first connect state, the first connect state being a single connection between the input port and a first output port, of the plurality of output ports, to a second connect state, the second connect state being a single connection between the input port and another predetermined output port of the plurality of output ports.

10. A method as defined in claim 9 wherein the input port is optically coupled to a first GRIN lens, the first GRIN lens for collimating the beam of light; and wherein a second GRIN lens is optically coupled to the plurality of output ports, the second GRIN lens for focussing the beam of light.

11. A method as defined in claim 9, wherein the step of inserting a light transmissive element into the optical path of the beam of light comprises using an actuator for moving said element in a direction essentially perpendicular to the refractive index gradient.

12. A method as defined in claim 9, further comprising the step of inserting a movable light transmissive bipartite element into the optical path said bipartite element having two opposing refractive index gradients.

13. A method as defined in claim 12, wherein the step of inserting a movable light transmissive bipartite element into the optical path comprises moving the movable light transmissive bipartite element into the optical path.

14. A method as defined in claim 10, wherein the input beam of light is substantially parallel to the optical axis of the first GRIN lens; and wherein the output beam of light is substantially parallel to the optical axis of the second GRIN lens.

15. A switch as defined in claim 1, wherein the light transmissive element is a multipartite element having a plurality of refractive index gradients.

16. A method as defined in claim 9, wherein the light transmissive element is a multipartite element having a plurality of refractive index gradients.

17. An optical switch comprising:
at least one input port on one side for launching a beam of light along an optical path;
at least two output ports on an opposite side for receiving the beam of light, one of the at least two output ports optically coupled to the at least one input port;
a light transmissive element, having a refractive index gradient, disposed in the optical path; and
means for controlling the refractive index gradient of said element.

18. An optical switch as defined in claim 17, wherein the means for controlling the refractive index gradient is means for thermally changing the refractive index gradient of the light transmissive element.

19. An optical switch as defined in claim 17, wherein the means for controlling the refractive index gradient is means for electro-optically changing the refractive index gradient of the light transmissive element.

20. An optical switch as defined in claim 17, wherein the means for controlling the refractive index gradient is means for elasto-optically changing the refractive index gradient of the light transmissive element.

21. A method for switching a beam of light from one of a plurality of output ports to another, comprising the steps of:
receiving a beam of light at an input port;
transmitting the beam of light along an optical path, with a light transmissive element, having a refractive index gradient, disposed therein, to at least one of a plurality of output ports; and
controlling the refractive index gradient to affect switching a beam of light between a first connect state, the first connect state being a single connection between the input port and a first output port, of the plurality of output ports, and a second connect state, the second connect state being a single connection between the input port and another predetermined output port of the plurality of output ports.

22. A method for switching a beam of light from one of a plurality of output ports to another, comprising the steps of:
receiving a beam of light at an input port;
transmitting the beam of light along an optical path to at least one of a plurality of output ports; and
moving a light transmissive element, having at least one refractive index gradient, disposed in the optical path;
whereby the beam of light switches from a first connect state, the first connect state being a single connection between the input port and a first output port, of the plurality of output ports, to a second connect state, the second connect state being a single connection between the input port and another predetermined output port of the plurality of output ports.
